(19) United States
(12) Patent Application Publication
(10) Pub. No.: US 2022/0033530 A1
(43) Pub. Date: Feb. 3, 2022

(54) AMINE FUNCTIONALIZED CHITIN FOR REMOVING MUNITIONS COMPOUNDS FROM SOLUTION

(71) Applicant: United States of America as Represented by The Secretary of The Army, Alexandria, VA (US)

(72) Inventors: Luke A. Gurtowski, Vicksburg, MS (US); Manoj K. Shukla, Clinton, MS (US); David P. Martin, Clinton, MS (US); Christopher S. Griggs, Vicksburg, MS (US)

(21) Appl. No.: 17/503,258

(22) Filed: Oct. 15, 2021

Related U.S. Application Data
(63) Continuation-in-part of application No. 16/144,954, filed on Sep. 27, 2018.
(60) Provisional application No. 62/574,732, filed on Oct. 19, 2017.

(51) Int. Cl. C08B 37/08; C08L 5/08

(52) U.S. Cl. CPC C08B 37/003; C08L 5/08

(57) ABSTRACT

The invention is a renewable adsorbent material, amine-functionalized chitin (AFC) that can remove the following munitions compounds from solution while providing a concentration-dependent color change: NTO, DNAN, and TNT. Adsorption of the munitions constituents can be adjusted by pH; neutral pH provides maximum adsorption. NTO can desorb from the AFC at pH levels of 2 and 12; DNAN and TNT remain attached to AFC once adsorbed.

### STATEMENT REGARDING FEDERALLY SPONSORED RESEARCH OR DEVELOPMENT

The invention described herein was made by an employee of the United States Government and may be manufactured and used by the Government of the United States of America for governmental purposes without the payment of any royalties thereon or therefore.

### FIELD OF INVENTION

This invention relates to the field of renewable adsorbent material, and more specifically to an amine-functionalized chitin (AFC) that can remove munitions compounds from solution.

### BACKGROUND OF THE INVENTION

The contamination of soil water from testing and disposal of munitions is a global concern. Common munitions (explosive) compounds such as Nitrotriazolone (NTO), 2,4-dinitroanisole (DNAN), and trinitrotoluene (TNT) can contaminate soil and groundwater are toxic, both acute and chronically. Munitions compounds are resistant to natural microbiological degradation. Even low levels can cause severe effects to an eco-system.

The Department of Defense (DoD) has estimated that, in the U.S. alone, munitions contaminated 15 million acres of land with clean-up costs ranging from $3-$35 billion.

Naturally occurring chitins have been successfully used to remove metal contaminants from water. However, the primary ingredient in common munitions compounds is nitrogen rather than metal. There are no naturally occurring chitins which bind to nitrogen and extract munitions contaminants at a high enough rate for effective remediation.

There is an unmet need for substances which can be produced in abundant supply to remove munitions compounds from underground water supplies, lakes, rivers and tributaries and oceans on global scale.

### SUMMARY OF THE INVENTION

The invention is a method for forming an amine functionalized chitin compound that includes forming an aqueous chitin sodium hydroxide solution, forming a chloroform tosyl chloride solution, and combining the aqueous chitin sodium hydroxide solution and the chloroform tosyl chloride solution to form a solution with tosyl chitin.

This solution separates into a target layer comprised of chloroform and tosyl chitin, and a hydrophilic layer which includes sodium hydroxide, chloride, and water.

The tosyl chitin extracted from the target layer is added to a solution that contains amine group molecules. The solution with tosyl chitin and amine group molecules is heated until the tosyl chitin separates into tosyl molecules and chitin molecules. Then the amine group molecules replace the tosyl molecules and bind to the chitin molecules to create amine functionalized chitin molecules within solution.

### BRIEF DESCRIPTION OF SEVERAL VIEWS OF THE DRAWING(S)

FIG. 1 illustrates chemical structures for amine functional groups AM1 and AM2 (prior art).

FIG. 2 illustrates an exemplary embodiment of the chemical structure for Amine-Functionalized Chitin (“AFC”) material.

FIG. 3 illustrates an exemplary embodiment of method 200 for synthesizing Amine-Functionalized Chitin (“AFC”) material.

FIG. 4 illustrates an exemplary embodiment of detailed method 200 for synthesizing Amine-Functionalized Chitin (“AFC”) material.

FIG. 5 illustrates exemplary removal percentages of NTO, DNAN, and TNT from solution by two embodiments of AFC material.

FIG. 6 illustrates exemplary removal percentages of varying concentrations of NTO, DNAN, and TNT by AFC material.

FIG. 7 illustrates exemplary effects of pH level on the removal percentages of NTO, DNAN, and TNT by AFC material.

### TERMS OF ART

As used herein, the term “2,4-dinitroanisole” (DNAN) means a munitions compound with the chemical structure of an anisole (methoxybenzene) core, with two nitro groups (—NO2) attached.

As used herein, the term “amine-exposed solution” means a solution with amine group molecules that are available for binding to other molecules.

As used herein, the term “amine functionalized chitin compound” (“AFC” compound) means a chitin molecule chain with N-acetylglucosamine units wherein each N-acetylglucosamine unit may have an amine group bound to it.

As used herein, the term “nitrotriazolone” (NTO) means a munitions compound with the chemical structure C₂H₂N₄O₃.

As used herein, the term “optimizing the yield of tosyl chitin by agitating” means creating motion within the solution to increase the interaction between tosyl group molecules and chitin molecules.

As used herein, the term “target layer” means a liquid layer containing dissolved tosyl chitin.

As used herein, the term “trinitrotoluene” (TNT) means a munitions compound with the chemical formula C₆H₂(NO₂)₃CH₃.

### DETAILED DESCRIPTION OF THE INVENTION

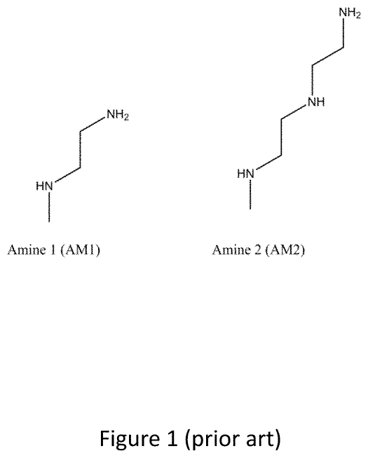

FIG. 1 illustrates chemical structures for amine functional groups AM1 and AM2 (prior art).

FIG. 1 illustrates two amine functional groups. AM1 is a chain with the following order of atoms: nitrogen, carbon, carbon, and nitrogen. AM2 is a chain with the following order of atoms: nitrogen, carbon, carbon, nitrogen, carbon, carbon, and nitrogen. Either amine functional group AM1 or AM2 may be attached to chitin to create Amine Functionalized Chitin (AFC) material.

Nucleophiles such as amine groups can form complexes with nitroaromatic compounds such as munitions compounds.

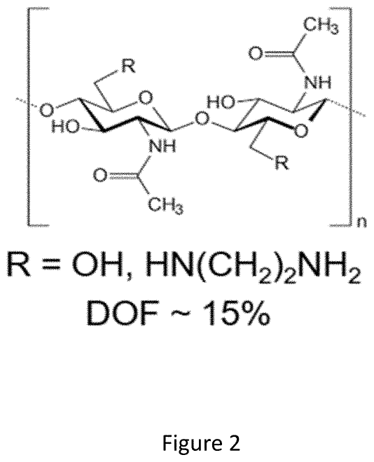

FIG. 2 illustrates an exemplary embodiment of the chemical structure for Amine-Functionalized Chitin (“AFC”) material.

The exemplary embodiment of AFC material shown is produced from chitin. Chitin is the world's second most abundant biopolymer, making it a renewable resource. Therefore, AFC material is a sustainable technology because its main ingredient is in high supply.

Chitin has the chemical formula C₁₆H₂₈N₂O₁₁ (C₈H₁₃NO₅)ₙ, with n number of N-acetylglucosamine units. In the exemplary embodiment shown, an amine group with the following order of atoms: nitrogen, carbon, carbon, and nitrogen may be bound to each N-acetylglucosamine unit in the chitin chain (represented in FIG. 2 as functional group R). The molecule has a degree of freedom measurement of approximately 15%. In various embodiments, alternative amine groups may be bound to each N-acetylglucosamine unit in the chitin chain.

The exemplary embodiment of AFC shown detects munitions compounds in water, including Nitrotriazolone (NTO), 2,4-dinitroanisole (DNAN), and trinitrotoluene (TNT). AFC material may be used as a renewable adsorbent for traditional and insensitive munition (IM) compounds. Compared to traditional munition compounds, insensitive munition compounds resist exploding when exposed to heat, shock, or the explosions of nearby munition.

In the exemplary embodiment shown, AFC in solid powder form displays a tan hue before operation. For the exemplary embodiment shown, when AFC is exposed to NTO, DNAN, or TNT in solution, the material immediately begins to change color. A steady-state (final) color is reached by 24 hours of exposure, according to preliminary lab evaluations; however, this color is likely reached within a much shorter time span. In various embodiments, AFC material will also react in the presence of a slurry made of munitions compound-contaminated soil mixed with water.

Regardless, each contaminant causes a distinct color change to AFC, allowing for the detection of the specific component. When exposed to NTO, this exemplary embodiment of AFC changes to light yellow. When exposed to DNAN, this exemplary embodiment of AFC changes to yellow. When exposed to TNT, this exemplary embodiment of AFC changes to a pink color. The intensity of this color depends upon the concentration of the contaminant within solution to which AFC is exposed. Therefore, expedient quantification of the contaminants is expected using this technology.

AFC material may be used as a renewable adsorbent for insensitive munition (IM) compounds. Based upon its pH dependence, it may be used as a regenerative adsorbent. Additionally, the material may be used for the purification of IMs including but not limited to NTO, DNAN, or TNT. The color change associated with the adsorption could be used for detection and colorimetric detection of IM compounds. This adsorbent material could potentially provide these benefits relative to other military materials, as well.

This material could be used as a renewable adsorbent for non-military contaminants. Based on its pH dependence, this material could be used as an easily regenerative absorbent for certain compounds. The selectivity of this adsorbent could provide purification of certain industrial waste streams. The color change associated with adsorbent could be used in sensing and quantification applications.

Additional advantages to using AFC material include increased sustainability of water treatment technology, and improved cost efficiency of water treatment for insensitive munition (IM) compounds. Using AFC material also provides colorimetric detection of traditional and insensitive munitions compounds when used as a sensing application, clear detection of munitions constituents, and expedited quantification of munitions constituents.

AFC material is also useful for sustainable removal of traditional and insensitive munition compounds from solution via adsorption, effective separation and purification of IM compounds, regenerative adsorption of insensitive munition compounds via pH adjustment, separation and purification of insensitive munition compounds via selective adsorption. Other potential contaminants could be removed from solution, detected, or quantified using this technology.

When AFC is added to solutions containing NTO, DNAN, and TNT, it removes these contaminants from solution via adsorption. This removal is pH-dependent, however, and is maximized at neutral pH levels. The pH dependence provides an additional benefit in that NTO can be desorbed at certain pH levels. This feature regenerates the adsorbent and extends its life. Additionally, NTO can be separated and purified from the other components.

Lastly, certain munition compounds, including nitroguandine (NQ) are impervious to various exemplary embodiments of AFC material. AFC material can selectively adsorb energetic compounds. This selective adsorption provides further separation and purification of the material. This property has not been observed for other commonly used adsorbents.

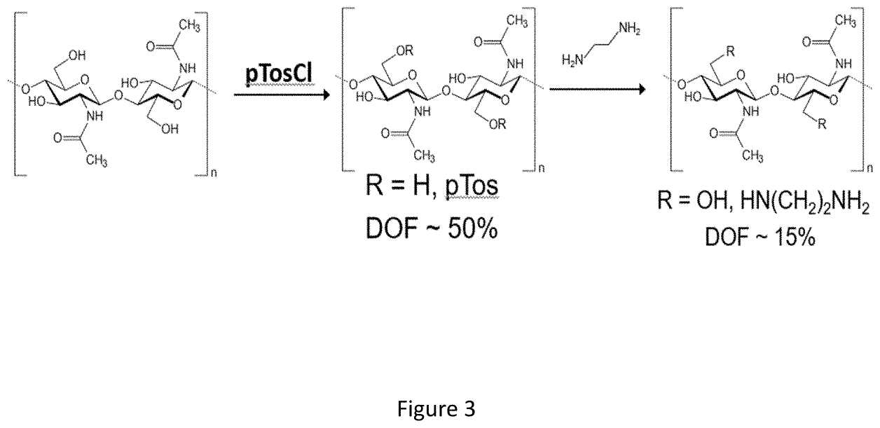

FIG. 3 illustrates an exemplary embodiment of method 200 for synthesizing Amine-Functionalized Chitin (“AFC”) material.

In the exemplary embodiment shown, synthesis of AFC material uses chitin and an amine-bearing organic material.

Step 1 is the step of adding a tosyl group to chitin.

Step 2 is the step of replacing the tosyl group with an amine functional group to create AFC material. “R” represents any amine group, but in the exemplary embodiment shown, it represents the amine group AM1 as depicted in FIG. 1, having a chain of atoms in the sequence nitrogen, carbon, carbon, nitrogen. In the exemplary embodiment shown, ethylenediamine provides the amine group AM1 for the reaction.

In an alternative embodiment, instead of an amine group, a thiol group replaces the tosyl group in step two.

In an alternative embodiment, chitosan or any polysaccharide may replace the chitin starting material. The synthesis method would be adjusted to accommodate the solubility of the chitosan or polysaccharide.

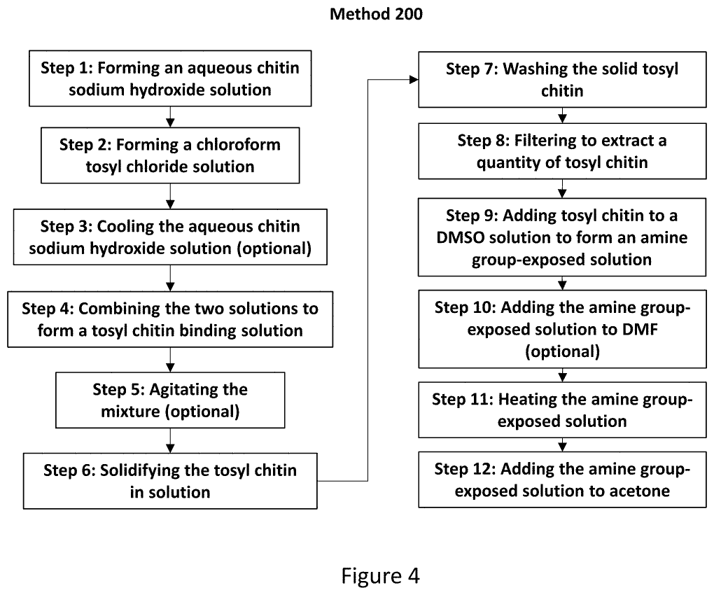

FIG. 4 illustrates an exemplary embodiment of method 200 for synthesizing Amine-Functionalized Chitin (“AFC”) material.

In the exemplary embodiment shown, synthesis of AFC material uses chitin and an amine-bearing organic material. In the embodiment shown, synthesizing AFC material includes the addition of a tosyl group to chitin, and the subsequent replacement of the tosyl group with an amine functional group. Because AFC is produced mostly from chitin, a renewable resource and the world's second most abundant biopolymer; it is a sustainable technology. Utilization of this material is favored because of this feature.

Step 1 is the step of forming an aqueous chitin sodium hydroxide solution in a first container.

In one exemplary embodiment, step 1 is the step of stirring 100 millimoles or mmol (4 grams) of sodium hydroxide (chemical formula NaOH) in 10 milliliters (mL) of water (chemical formula H₂O) at room temperature until the sodium hydroxide has dissolved.

After dissolving the sodium hydroxide, step 1 further includes the step of stirring 3.05 mmol (500 milligrams or mg) of chitin (chemical formula C₁₆H₂₈N₂O₁₁(C₈H₁₃NO₅)ₙ) in the aqueous sodium hydroxide solution until the chitin has dissolved. In this exemplary embodiment, stirring for approximately 15 minutes dissolved the chitin in the solution.

Step 2 is the step of forming a chloroform tosyl chloride solution in a second container.

In one exemplary embodiment, step 2 is the step of dissolving 45.8 mmol (8.7 grams) of tosyl chloride (chemical formula CH₃C₆H₄SO₂Cl) in 20 mL of chloroform (chemical formula CHCl₃).

Step 3 is the optional step of cooling the aqueous chitin sodium hydroxide solution.

In one exemplary embodiment, the aqueous chitin and sodium hydroxide mixture cools in an ice bath, and continues to cool for a total of 2 hours, while being stirred.

Step 4 is the step of combining the aqueous chitin sodium hydroxide solution and the chloroform tosyl chloride solution to form a tosyl chitin binding solution.

The tosyl chitin binding solution yields tosyl chitin, which has a tosyl group bound to each N-acetylglucosamine unit in the chitin chain.

In one exemplary embodiment, the chloroform tosyl chloride solution is added to the aqueous chitin sodium hydroxide solution while it is stirred and cooled in an ice bath. The reaction that occurs when these solutions are combined releases a significant amount of heat, so cooling the mixture avoids flash boiling of the organic layer.

Step 5 is the optional step of agitating the mixture.

This step maximizes the interaction between the two layers of solution (the water (i.e. aqueous or hydrophilic) layer and the chloroform (i.e. organic or hydrophobic layer). Maximizing the interaction between these two layers increases the exposure of tosyl group molecules to chitin molecules.

In one exemplary embodiment, step 5 is the step of removing the mixture from the ice bath after 2 total hours of cooling and stirring the mixture at room temperature for 2 hours.

Step 6 is the step of solidifying the tosyl chitin in solution.

In one exemplary embodiment, the mixture is poured into 100 mL of water (H₂O), which causes the tosyl chitin to solidify (i.e. precipitate) within the solution.

Step 7 is the step of washing the solid tosyl chitin.

In one exemplary embodiment, the step of washing is achieved by repeated decanting. In this embodiment, the solid tosyl chitin is maintained in the container while excess liquid is poured into a separate container and discarded. In one exemplary embodiment, this decanting process where water is added to the solution containing the solid tosyl chitin, then the solid tosyl chitin is maintained in the container while excess liquid is discarded is repeated several times.

Step 8 is the step of filtering to extract a quantity of tosyl chitin.

In one exemplary embodiment, a 10 cm vacuum filter is used to process the solid tosyl chitin and the solution containing it. Any liquid passes through the vacuum filter, leaving the tosyl chitin in solid form on the filter, then water (H₂O) passes through the filter to wash the solid tosyl chitin, then methanol (MeOH) passes through the filter to remove any remaining tosyl chloride from the solid tosyl chitin. The water and methanol wash steps are repeated several times, then the vacuum dries the solid tosyl chitin on the filter so that the solid tosyl chitin may be collected by scraping the dried solid from the filter.

Step 9 is the step of adding the extracted tosyl chitin to a DMSO solution to create an amine group-exposed solution.

In one exemplary embodiment, this DMSO solution includes dimethyl sulfoxide (DMSO) and a source of amine group molecules.

In one exemplary embodiment, this DMSO solution includes a 40 mL of DMSO, 283 mg of triethylamine, and 1.68 g of ethylenediamine for each 1 gram of said tosyl chitin added to this DMSO solution. Ethylenediamine provides the AM1 functional group shown in FIG. 1.

In one exemplary embodiment, the tosyl chitin DMSO solution is stirred at room temperature to dissolve all solids.

Step 10 is the optional step of adding the amine group-exposed solution to dimethylformamide (DMF).

This step tests whether a water-soluble product exists. In one exemplary embodiment, the amine group-exposed solution is poured into 25 mL of DMF.

Step 11 is the step of heating the amine group-exposed solution.

This step includes heating the amine group-exposed solution until the tosyl groups separate from the chitin molecules and the amine group molecules bind to the chitin molecules to create amine functionalized chitin molecules within the DMSO solution.

Heating speeds up the reaction, which (along with using a large excess of amine) helps avoid crosslinking (i.e. the amine of a functionalized chitin molecule reacting with an unfunctionalized chitin to form a bridging ethylene group).

In one exemplary embodiment, the amine group-exposed solution is heated to 70° C. and held at that temperature for 8-16 hours.

Step 12 is the optional step of pouring the amine group-exposed solution into acetone.

This step isolates the amine functionalized chitin molecules in a solid form. In one exemplary embodiment, the amine group-exposed solution is poured into 250 mL of acetone. This step causes the amine functionalized chitin molecules to precipitate into solid form in the solution, to facilitate collection of solid AFC material.

In an alternative embodiment of Method 200, chitin (30 g) and NaOH (100 g) were added to 250 mL water and stirred overnight, then cooled in an ice bath with continuous stirring. Tosyl chloride (250 g) dissolved in chloroform (400 mL) and was then added to the chitin NaOH solution with vigorous stirring. The biphasic mixture was stirred for a total of 4 h, and was allowed to warm to room temperature after 2 h. The mixture was then poured into 1 L of water, which resulted in precipitation of the product. The mixture was decanted and washed with several 500 mL aliquots of water until the pH of the supernatant was neutral. The product was then filtered and washed several times with methanol to remove any remaining tosyl chloride before drying at 60° C. Yield: 37.4 g. The degree of functionalization was estimated to be 50% based on elemental analysis (47.63% C, 5.58% H, 4.57% N, 5.76% S; starting material 43.59% C, 6.83% H, 6.01% N, 0.6% S) and the presence of the tosyl group was confirmed by the appearance of characteristic IR absorption peaks (aromatic C—H bending at 814 nm, symmetric SO₂ stretching at 1177 nm).

In one exemplary embodiment that replaced the tosyl group with amine group 1 (AM1) as depicted in FIG. 1, a mixture of ethylenediamine (50 mL) and DMSO (300 mL) was heated to 50° C. prior to the addition of chitin-pTos (35 g). The solution was then heated to 70° C. for 24 h and allowed to cool to room temperature. The mixture was poured into acetone (750 mL) and the resulting precipitate was filtered and washed several times with methanol before drying at 60° C. The degree of functionalization was estimated to be 15% based on elemental analysis (45.75% C, 6.42% H, 8.13% N, 1.47% S) with tosyl group removal confirmed by the disappearance of the characteristic IR absorption peaks.

In one exemplary embodiment that replaced the tosyl group with amine group 2 (AM2) as depicted in FIG. 1, a mixture of diethylenetriamine (50 mL) and DMSO (50 mL) was heated to 70° C. prior to the addition of chitin-pTos (35 g). The solution was then heated to 70° C. for 24 h and allowed to cool to room temperature. The mixture was poured into acetone (750 mL) and the resulting precipitate was filtered and washed several times with methanol before drying at 60° C. The degree of functionalization was estimated to be 7% based on elemental analysis (45.52% C, 6.49% H, 7.94% N, 1.33% S).

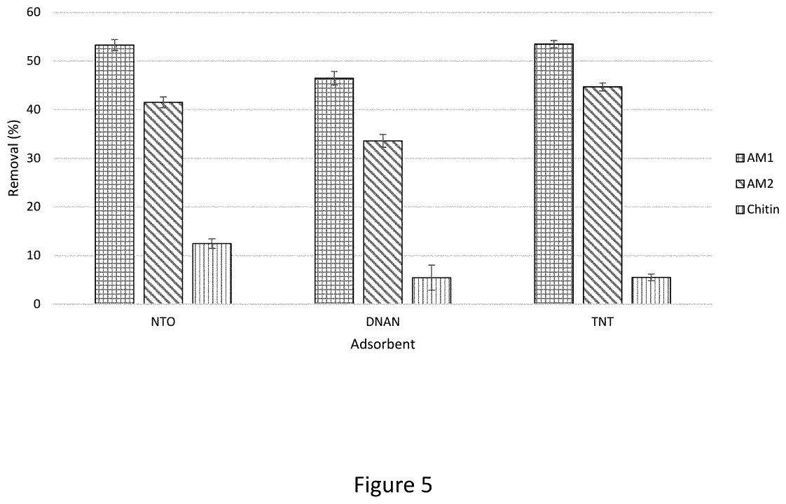

FIG. 5 illustrates exemplary removal percentages of NTO, DNAN, and TNT from solution by two embodiments of AFC material.

In this exemplary embodiment, AFC material (in a quantity of 100 grams) extracted nitrotriazolone (NTO), 2,4-dinitroanisole (DNAN), or trinitrotoluene (TNT) individually from three separate solutions with a volume of 10 mL and a concentration of 10 mg/L. The AFC experienced color changes related to the munitions compound to which it was exposed. NTO, DNAN, and TNT provided light yellow, dark yellow, and pink hues, respectively (not shown).

Quantitative analysis via High Performance Liquid Chromatography (HPLC) showed that AFC functionalized with amine group 1 (AM1, depicted in FIG. 1) removed approximately 50% of each munitions constituent from solution after 24 hours of exposure. The AFC functionalized with amine group 2 (AM2, depicted in FIG. 1) removed approximately 40% of each munitions constituent from solution after 24 hours of exposure.

Plain chitin extracted between 5% and 12% of the munitions compounds from solution.

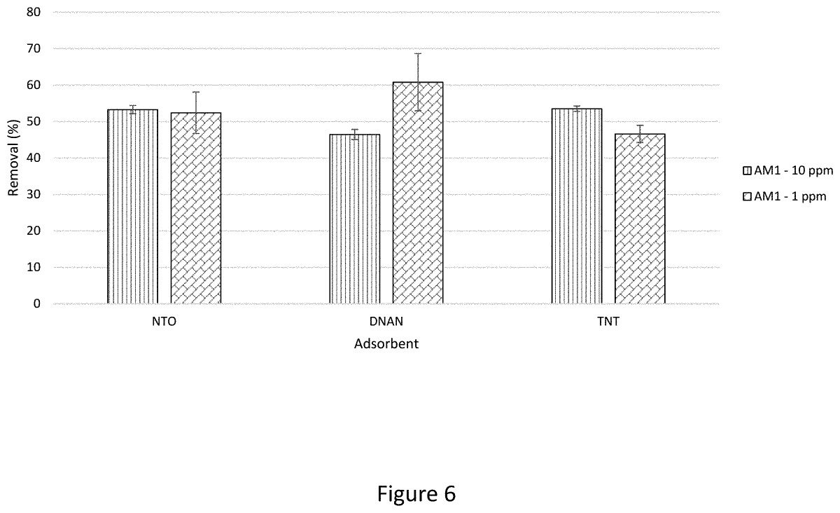

FIG. 6 illustrates exemplary removal percentages of varying concentrations of NTO, DNAN, and TNT by AFC material.

The AFC material (in a quantity of 100 grams) extracted nitrotriazolone (NTO), 2,4-dinitroanisole (DNAN), or trinitrotoluene (TNT) individually from three separate solutions with a volume of 10 mL and a concentration of either 10 mg/L (10 ppm) or 1 mg/L (1 ppm). Quantitative analysis via High Performance Liquid Chromatography (HPLC) showed that AFC functionalized with amine group 1 (AM1, depicted in FIG. 1) removed approximately 50% of each munitions constituent from each munition solution after 24 hours of exposure, at both concentrations.

When 100 grams of AFC encountered 1 mg/L concentrations of munitions solutions, the color changes were less intense than when AFC encountered 10 mg/L solutions (not shown). When 100 grams of AFC encountered 50 mg/L concentrations of munitions solutions in 18.2 MO water, the color changes were more intense than when AFC encountered 10 mg/L solutions (not shown). These data indicate a dependence of the color intensity on the concentration of the munition compound in solution, providing a potential for not only detection but also quantification.

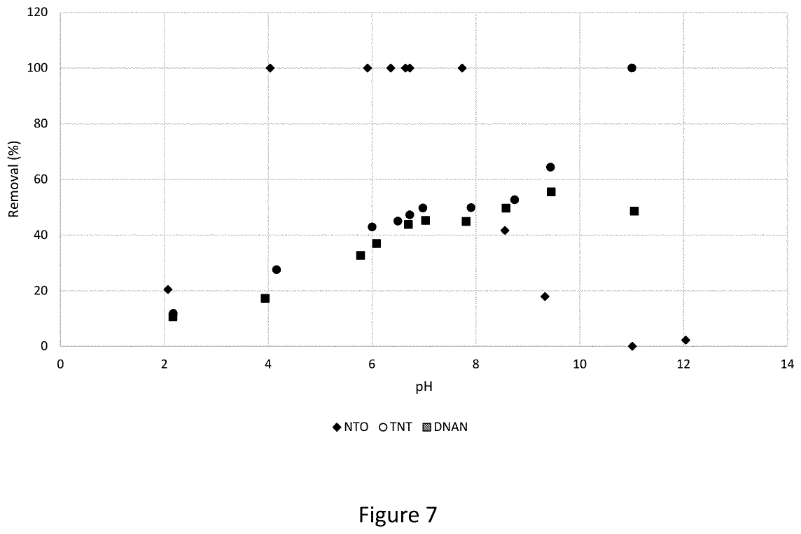

FIG. 7 illustrates exemplary effects of pH level on the removal percentages of NTO, DNAN, and TNT by AFC material.

The AFC material (in a quantity of 100 grams) extracted nitrotriazolone (NTO), 2,4-dinitroanisole (DNAN), or trinitrotoluene (TNT) individually from solutions with a volume of 10 mL, a concentration of 1 mg/L (1 ppm), and one of eleven pH levels between 2 and 12. additional AFC functionalized with AM1 was produced. Sodium hydroxide (NaOH) and hydrochloric acid (HCl) controlled pH levels. The greatest adsorption and removal of munitions compounds occurs at a neutral pH; alkaline hydrolysis of TNT and DNAN occurs at high pH and skews the data.

Further experimentation showed that when the pH was lowered to 2 after adsorption at a neutral pH occurred, 67% of the NTO desorbed into solution. However, DNAN and TNT did not desorb at this pH. The experiment was repeated for NTO such that the pH was raised to 12 after adsorption at a neutral pH, and 77% of the NTO was desorbed. This experiment was not conducted for DNAN and TNT because alkaline hydrolysis would skew the results.

Therefore, these results show than AFC can be regenerated by change in pH of the feed solution. NTO, specifically, can be desorbed into solution when the pH is lowered to 2 or raised to 12. This feature extends the life of the adsorbent and, because DNAN and TNT are not desorbed, further provides separation and purification of munitions constituents. This property has not been observed for other commonly used adsorbents.

What is claimed is:

1. A method for forming an amine functionalized chitin compound comprised of the steps of:
forming an aqueous chitin sodium hydroxide solution;
forming a chloroform tosyl chloride solution;
combining said aqueous chitin sodium hydroxide solution and said chloroform tosyl chloride solution to form a tosyl chitin binding solution that contains tosyl chitin;
wherein said tosyl chitin is comprised of chitin molecules with tosyl molecules bound to said chitin molecules;
solidifying said tosyl chitin;
washing solidified tosyl chitin;
filtering said solidified tosyl chitin to extract a quantity of tosyl chitin;
adding said tosyl chitin to a DMSO solution to create an amine group-exposed solution;
wherein said DMSO solution includes dimethyl sulfoxide (DMSO) and amine group molecules; and
heating said DMSO solution until said tosyl molecules separate from said chitin molecules and said amine group molecules bind to said chitin molecules to create amine functionalized chitin molecules within said DMSO solution.

2. The method of claim 1, wherein said aqueous chitin sodium hydroxide solution is comprised of a volume of water and 500 mg of chitin for each 10 mL volume of water and 4 grams of sodium hydroxide for each 10 mL volume of water.

3. The method of claim 1, wherein said chloroform tosyl chloride solution is comprised of a volume of chloroform and 8.7 grams of tosyl chloride for each 20 mL volume of chloroform.

4. The method of claim 1, wherein the step of combining said aqueous chitin sodium hydroxide solution and said chloroform tosyl chloride solution occurs in a cooling environment having a temperature of approximately 0° C.

5. The method of claim 1, which further includes the step of optimizing the yield of tosyl chitin by agitating said tosyl chitin binding solution to increase the interface between said target layer and said hydrophilic layer to facilitate binding of said tosyl molecules and said chitin molecules.

6. The method of claim 5, wherein agitating is done by stirring said tosyl chitin binding solution.

7. The method of claim 1, wherein the step of filtering further includes rinsing said quantity of tosyl chitin with water and methanol.

8. The method of claim 1, wherein said DMSO solution includes a quantity of DMSO, ethylenediamine, and triethylamine.

9. The method of claim 8, wherein said DMSO solution is comprised of 40 mL of said DMSO, 283 mg of said triethylamine, and 1.68 g of said ethylenediamine for each 1 gram of said tosyl chitin added to said DMSO solution.

10. The method of claim 1, wherein said amine group molecules includes an amine derived from a group consisting of: ethylenediamine and diethylenetriamine.

11. The method of claim 1, wherein said amine group molecules include an amine derived from a molecule containing at least two primary amines.

12. The method of claim 1, wherein each of said amine group molecules consist of atoms in the following order: nitrogen, carbon, carbon, and nitrogen.

13. The method of claim 1, wherein each of said amine group molecules consist of atoms in the following order: nitrogen, carbon, carbon, nitrogen, carbon, carbon, and nitrogen.

14. The method of claim 1, wherein each of said amine group molecules includes more than four carbon atoms.

15. The method of claim 1, wherein each of said amine group molecules includes more than three nitrogen atoms.

16. The method of claim 1, wherein each of said amine group molecules includes additional atoms selected from a group consisting of: nitrogen, carbon, and hydrogen.

17. The method of claim 1, wherein the step of heating said DMSO solution includes placing said DMSO solution in an environment with a temperature of approximately 70° C. to 100° C.

18. The method of claim 1, wherein the step of heating said DMSO solution includes placing said DMSO solution in a heated environment for approximately 8 to 16 hours.

19. The method of claim 1, wherein each of said chitin molecules is a chain comprised of repeating N-acetylglucosamine units.

20. The method of claim 1, which further includes the step of pouring said amine functionalized chitin molecules in said DMSO solution into acetone to isolate said amine functionalized chitin molecules in a solid form.
